(19) United States
(12) Patent Application Publication
(10) Pub. No.: US 2004/0052695 A1
(43) Pub. Date: Mar. 18, 2004

(54) Catalytic converter

(75) Inventors: Helmut Schlessmann, Prum (DE); Jorg Schlossarczyk, Winnenden (DE); Holger Lochmann, Waiblingen (DE)

Correspondence Address: ROBERT W. BECKER & ASSOCIATES, Suite B, 707 Highway 66 East, Tijeras, NM, 87059, US

(73) Assignee: Andreas Stihl AG & Co., KG, Waiblingen (DE)

(21) Appl. No.: 10/659,839

(22) Filed: Sep. 11, 2003

(30) Foreign Application Priority Data
Sep. 17, 2002 (DE) 102 42 869.7

(51) Int. Cl. B01D 53/34

(52) U.S. Cl. 422/177

(57) ABSTRACT

A catalytic converter for the after-treatment of the exhaust gas from an internal combustion engine is provided. The catalytic converter has a housing having an internal space for receiving exhaust gas therethrough. Surfaces of walls of the housing facing the internal space are at least partially provided with catalytically active material in a flow path between inlet and outlet openings for exhaust gas. Hollow domes are provided on oppositely disposed walls of the housing, and extend into the internal space. The free ends of the hollow domes are provided with the outlet openings, and the free ends of those hollow domes on one of the walls extend beyond the free ends of the hollow domes of the oppositely disposed wall.

### BACKGROUND OF THE INVENTION

The present invention relates to a catalytic converter for the after-treatment of the exhaust gas from an internal combustion engine, in particular for manually operated tools.

A muffler is known from WO 97/01023 in the internal space of which there is positioned a catalytic converter designed as a separating wall. The catalytic converter housing consists of two essentially flat metal plates, one of which has several inlet openings while the other has one outlet opening, through which the exhaust gas flows into the chamber of the muffler positioned to the rear of the engine through the two plates one after the other. The wall sections of the metal plates are provided at least partially along the flow path between the inlet openings in the first plate and the outlet opening in the second plate with a catalytically active coating which draws pollutants from the exhaust gas as it flows through. The flow of exhaust gas is bound to enter the known catalytic converter housing through a plurality of small openings where it hits the second catalytic converter wall directly, often causing the catalytic converter arrangement to have an undesired throttling effect on the exhaust gas as it flows through.

The object of the present invention is to create a catalytic converter of the aforementioned general type of small size which guarantees effective exhaust gas after-treatment without throttling the exhaust gas as it flows through.

### SUMMARY OF THE INVENTION

This object is realized by an inventive catalytic converter that comprises a housing having an internal space for receiving exhaust gas flowing therethrough, wherein surfaces of walls of the housing that face the internal space are at least partially provided with catalytically active material in a flow path between inlet and outlet means for exhaust gas, whereby formed on two opposite sides of the catalytic converter housing are hollow domes which project into the internal space, have openings at their free ends and extend beyond the free ends of the hollow domes on the opposite housing wall. In this arrangement, the exhaust gas is diverted several times through the spaces between the individual hollow domes, thereby achieving a thorough mixing of the flow of exhaust gas and effective contact with the catalytically active surfaces in the internal space. The exhaust gas flows through the catalytic converter space both in the direction of the hollow domes and transversely between the hollow domes. Advantageously, a plurality of hollow domes is provided on each of the housing walls, projecting into the spaces between the hollow domes on the opposite housing wall and thereby giving a very large area for the provision of catalytically active surfaces with a very small catalytic converter housing. In addition to a long flow path along which catalytically active areas are provided, the intermeshing of the offset hollow domes on the opposite housing wall also diverts the flow of gas flow sharply and creates a very thin boundary layer, thereby producing a fluidically favorable flow of exhaust gas with a high mass flow rate in the catalytic converter.

Advantageously, the housing is made up of two preformed metal plates, each of these preformed metal plates having a housing wall provided with hollow domes. When the preformed metal plates are put together, the inwardly projecting hollow domes are pushed into the spaces between the hollow domes on the other preformed metal plate, and assembly of the catalytic converter housing with the hollow domes disclosed in the invention is therefore simple. The preformed metal plates can be manufactured as solid drawn metal plates, the hollow domes being drawn with the openings made in them thereby forming a rounded section at the foot of the plate plane extending as far as its free end in a manner which is also favorable in fluidic terms. In this way, the hollow domes disclosed in the invention can be drawn using a simple manufacturing process. The preformed metal plates usefully join each other at a peripheral flange collar where they are fixed together, the edge beading of the preformed metal plates in the area of the flange collar being the proposed method of fixing. In this arrangement, one of the preformed metal plates is advantageously pot-like in shape and bears the flange collar while the other preformed metal plate is essentially flat with hollow domes standing out from the plate plane and with a bearing edge extending beyond the area provided with the hollow domes on which the pot-shaped preformed metal plate can be placed. However, it can also be useful to make both preformed metal plates pot-shaped with approximately the same height of lateral wall as far as the flange collar.

The hollow domes are advantageously of cylindrical design, thereby producing advantageous flow phenomena in particular transversely between the domes. With a view to simplifying the drawing process, the hollow domes can also be designed as cones tapering towards their free ends.

The hollow domes advantageously extend through the entire internal space of the catalytic converter housing as far as the opposite housing wall, thereby forming a flow gap between the free ends and the housing wall lying opposite the opening. The diversion of the flow of exhaust gas by some 180° produces high flow speeds in the diversion area, and the associated increase in kinetic energy also causes a cross-flow even between remote hollow domes and therefore an even surface load on the preformed metal platted metal plates. In this arrangement, the width of the flow gap is determined in such a manner that no throttling of the flow of exhaust gas is produced. It is possible to oppose an undesired increase in temperature by the appropriate variation of the flow gap. The further the flow domes on the opposing housing walls are pushed towards each other and the smaller the resulting flow gap, the better the performance of the catalytic converter. In order to cool the catalytic converter it is possible to increase the width of the gap so that although less exhaust gas is subject to catalytic conversion of pollutants, the percentage of the exhaust gas carried with it, which has a cooling effect on the catalytic converter, increases with the width of the gap.

The openings at the free ends of the hollow domes usefully form the outlet of the catalytic converter, the inlet being provided as a window in one of the preformed metal plates forming the housing. Thus the window can be connected to an exhaust train or section in the internal combustion engine by a short flow path. The catalytic converter is usefully designed as an intermediate housing for use in a muffler, it being possible for the inlet window of the catalytic converter housing to overlap with an inlet window in the muffler which has similar dimensions. The exhaust gas therefore flows through the inlet window into the catalytic converter housing, from whence following catalytic treatment along the hollow domes it enters the internal space of the muffler. In this manner there is formed a compact assembly comprising muffler and catalytic converter housing which is easy to handle and can be fitted to the internal combustion engine of a small manually operated tool in a space saving manner. In the catalytic converter housing disclosed in the invention it is possible to provide overlapping holes in the two opposite wall sections in which can be received the fixing elements passing through the housing to fix the muffler and the catalytic converter housing to the internal combustion engine.

### BRIEF DESCRIPTION OF THE DRAWINGS

An embodiment of the invention is explained in greater detail below with reference to the schematic drawings, in which:

FIG. 1 shows a side view of a catalytic converter housing as disclosed in the invention,

FIG. 2 shows a section of the catalytic converter housing along the line marked A-A in FIG. 1,

FIG. 3 shows an exploded perspective view of the catalytic converter housing disclosed in the invention, and

FIG. 4 shows a perspective view of a muffler.

### DESCRIPTION OF PREFERRED EMBODIMENTS

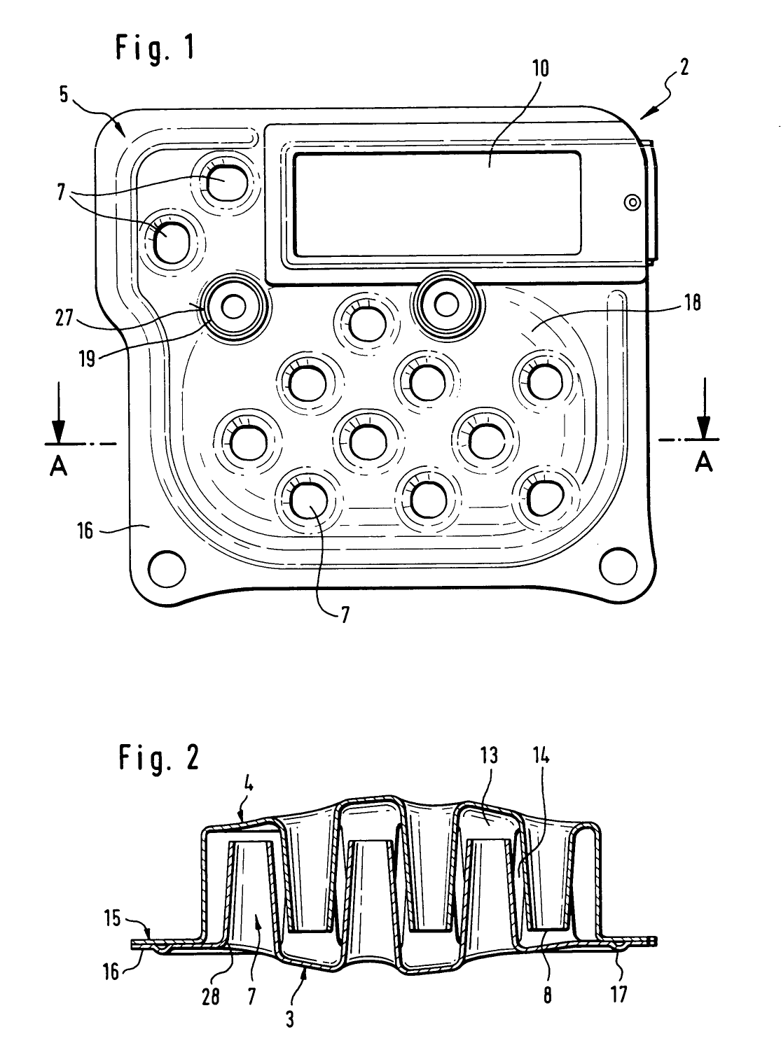

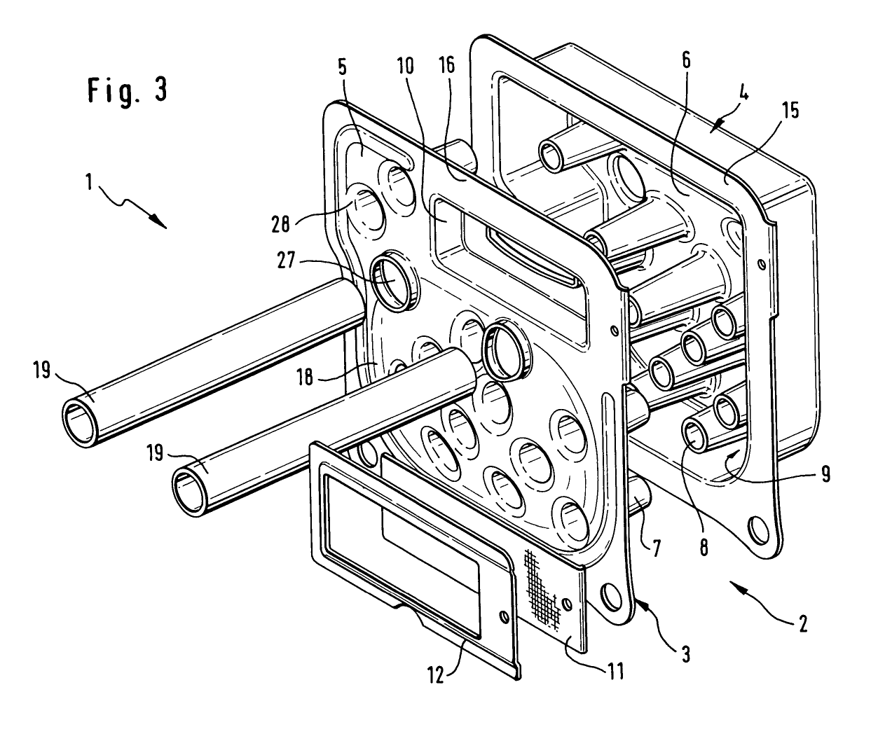

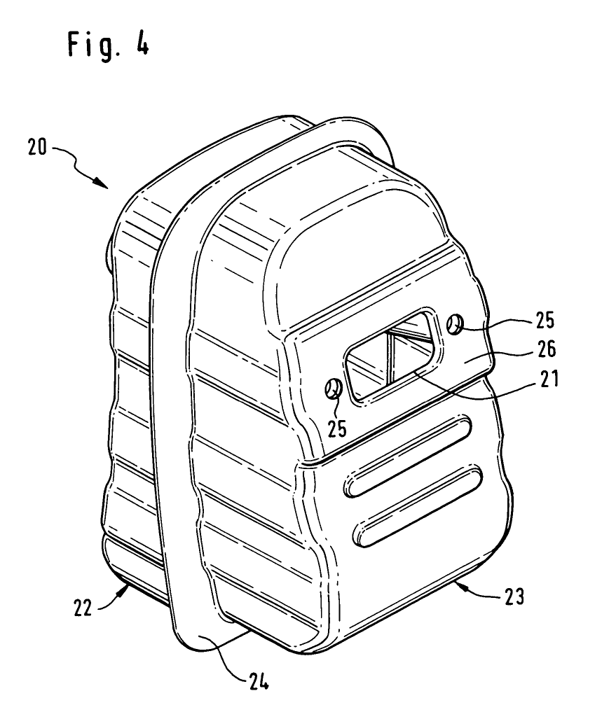

FIGS. 1 to 3 show a housing 2 for a catalytic converter 1 and comprises preformed metal plates or sections 3 and 4. For the sake of simplicity, the same reference numerals are used for the same components in each case. The preformed metal plates 3 and 4 are manufactured as drawn metal parts and delimit an internal space 9 in which surfaces with catalytically active coatings are able to react with the exhaust gas as it flows through. The preformed metal plates 3,4 lie adjacent to one another in a common flange plane. In the illustrated embodiment, the preformed metal plate 4 is designed in a pot-like shape and has a flange collar 15 around its periphery, while the other preformed metal plate 3 is of essentially flat design and has a peripheral edge 16 which, with the dimensions of the flange collar, lies on the flange collar 15 of the opposing preformed metal plate 4. The preformed metal plates 3 and 4 are connected together along the flange collar by means of an edge bead 17. One of the preformed metal plates, in this case the flat preformed metal plate part 3, is provided with an outlet window 10 for the outflowing exhaust gas which is connected to the exhaust pipe of an internal combustion engine which is not illustrated here. The outlet window 10 is protected by a spark screen 11 which is received in a frame 12.

The catalytic converter housing 2 is received in a housing for a muffler 20 which is illustrated in FIG. 4. The muffler comprises two pot-shaped container halves 22,23 which are fixed together by means of a flange 24 running around their peripheries. Housing half 23 has a bearing surface 26 arholes for mounting on the internal combustion engine, in which surface is an inlet window (21) which provides access for the exhaust gas to flow into the muffler housing. Provided in the bearing surface 26 are holes 25 for mounting the housing. Introduced through these holes into the internal combustion engine are fitting screws which also pass through the catalytic converter housing 2 received in the muffler 20. The catalytic converter housing is received in the muffler 20 in such a manner that the inlet window 10 in the catalytic converter 1 overlaps the muffler inlet illustrated in FIG. 4. Provided in both preformed metal plates 3,4 of the catalytic converter housing 2 are overlapping holes 27 through which are introduced screws for mounting the muffler which therefore simultaneously fix the catalytic converter housing in place. In order to simplify assembly, assembly pipes 19 are provided in the holes 27 in the catalytic converter housing 2.

Having entered the catalytic converter housing 2, the exhaust gas flows out through the base of the pot-shaped preformed metal plate 4 and the opposing wall of the other preformed metal plate 3. In the invention, the openings 8 through which the exhaust gas flows out are provided at the free ends of hollow domes 7 which are designed to project from the two opposite housing walls 5, 6 of the preformed metal plates 3,4. In this arrangement, each preformed metal plate 3,4 bears a plurality of hollow domes which project into the internal space 9 of the catalytic converter housing 2 and thereby are pushed far beyond the holes 8 in the opposite hollow domes 7. Here the hollow domes 7 are arranged such that when the preformed metal plates 3,4 are fitted together they project into the space between the hollow domes on the other housing half. The hollow domes may advantageously be designed as cylinders. With a view to achieving a simple production process for the preformed metal plates using a drawing process, in this embodiment the hollow domes 7 are designed as truncated cones which taper towards their free ends.

The cross-section of the catalytic converter housing illustrated in FIG. 2 shows a multi-angled flow path through the hollow domes 7 inserted adjacent one another as disclosed in the invention in the preformed metal plates 3 and 4 which are fixed by means of edge beads 17 at the flange collar 15. In this arrangement, the flow of exhaust gas in the catalytic converter housing is diverted at an angle of almost 180° in the area of the openings 8 at the free ends of the hollow domes 7, thereby mixing the exhaust gas thoroughly. The high kinetic energy in the area of the diversion of the flow of exhaust gas simultaneously effects a balancing flow movement across the housing 2 and the exhaust gas therefore reaches even the more remote hollow domes and an even surface load of both preformed metal plates 3, 4 is achieved.

The hollow domes 7 extend into the space between the hollow domes 7 in the other preformed metal plate 3,4 almost as far as its base, a flow path 13 being formed between the housing wall of the preformed metal plate 3,4 in question and the free end of the hollow domes. By setting the depth by which the hollow domes 7 project into the space between the hollow domes 7 in the other preformed metal plate 3,4 it is possible to design the opening area of the flow gap 13 and the passage 14 in the surface region of the hollow domes 7 in such a way that an unthrottled throughput is achieved. In this arrangement, the outer surfaces of the hollow domes are provided with a catalytically active coating which effectively frees the exhaust gas of pollutants as it flows past. It has proved useful to provide a gap width of 2 mm to 3 mm, preferably 2.4 mm, for the flow gap 13 in the area of the catalytic converter housing for manually operated tools. It can also be advantageous to provide the housing walls 5,6 of the preformed metal plates 3,4 which are provided with hollow domes 7 with a convex area 18, thereby enlarging the internal space between the hollow domes at a variable width for the flow gap 13. In this manner it is possible to counter any undesired heating up of the catalytic converter housing 2 by also conveying a cooling trailing flow in the core area of the flow with an outer boundary layer which flows along the surfaces of the catalytic converter.

The specification incorporates by reference the disclosure of German priority document 102 42 869.7 filed Sep. 17, 2002.

The present invention is, of course, in no way restricted to the specific disclosure of the specification and drawings, but also encompasses any modifications within the scope of the appended claims.

We claim:

1. A catalytic converter for the after-treatment of exhaust gas of an internal combustion engine, comprising:
a housing having an internal space for receiving exhaust gas therethrough, wherein surfaces of walls of said housing facing said internal space are at least partially provided with catalytically active material in a flow path between inlet and outlet means for exhaust gas, and hollow domes disposed on oppositely disposed walls of said housing, wherein said hollow domes extend into said internal space, wherein free ends of said hollow domes are provided with said outlet means, and wherein the free ends of those hollow domes on one of said walls extend beyond free ends of those hollow domes of the oppositely disposed wall.

2. A catalytic converter according to claim 1, wherein a plurality of hollow domes are provided on each of said oppositely disposed wall of said housing, and wherein the hollow domes on one of said walls extend into spaces between the hollow domes of the oppositely disposed wall.

3. A catalytic converter according to claim 1, wherein said housing is composed of two shell portions each of which is provided with one of said oppositely disposed walls.

4. A catalytic converter according to claim 3, wherein said shell portions are one-piece drawn parts of plate metal.

5. A catalytic converter according to claim 1, wherein said hollow domes have an essentially cylindrical configuration.

6. A catalytic converter according to claim 5, wherein said hollow domes have a conical configuration that tapers towards said free ends thereof.

7. A catalytic converter according to claim 1, wherein said free ends of said hollow domes extend nearly to the oppositely disposed wall while forming a flow gap.

8. A catalytic converter according to claim 7, wherein the flow gap of outwardly disposed ones of said hollow domes has a reduced cross-section.

9. A catalytic converter according to claim 1, wherein outer surfaces of said hollow domes are provided with a catalytically active coating.

10. A catalytic converter according to claim 3, wherein said shell portions rest against one another via a peripheral flange collar.

11. A catalytic converter according to claim 10, wherein said shell portions are connected by means of an edge bead in the vincinity of said flange collar.

12. A catalytic converter according to claim 10, wherein one of said shell portions has a pot-shaped configuration and is provided with said flange collar, wherein the other of said shell portions is provided with an abutment edge that is guided beyond a region of one of said oppositely disposed walls that is provided with said hollow domes, and wherein said abutment edge has the dimensions of said flange collar.

13. A catalytic converter according to claim 1, wherein said outlet means provided on said free ends of said hollow domes form an outlet for said catalytic converter.

14. A catalytic converter according to claim 1, which is embodied for use in a muffler and forms an inlet of said muffler.

15. A catalytic converter according to claim 14, wherein when said catalytic converter is installed in said muffler, an inlet means of said housing in the form of an inlet window is disposed at the same level as an inlet opening of said muffler.

16. A catalytic converter according to claim 14, wherein said housing is provided with aligned holes for receiving fixing or mounting elements that extend through said housing.
